(19) United States
(12) Patent Application Publication
(10) Pub. No.: US 2019/0010063 A1
(43) Pub. Date: Jan. 10, 2019

(54) DEIONIZATION DEVICE

(71) Applicant: ETS Trade S.a.r.l., Wasserbilling (LU)

(72) Inventor: Harald Schmidt, Dorth (DE)

(21) Appl. No.: 16/065,521

(22) PCT Filed: Dec. 22, 2016
(86) PCT No.: PCT/EP2016/082336

§ 371 Date: Jun. 22, 2018

(30) Foreign Application Priority Data
Dec. 23, 2015 (DE) 10 2015 122 761.4

(51) Int. Cl. C02F 1/42; B01D 15/36; B01D 15/20; B01J 47/028; B01J 49/08; B01J 39/18; B01J 41/12

(52) U.S. Cl. CPC C02F 1/42; B01D 15/362; B01D 15/363; B01D 15/203; B01J 47/028; B01J 49/08; C02F 2303/16; B01J 41/12; C02F 2201/004; C02F 2201/005; C02F 2201/003; C02F 2001/422; C02F 2001/425; B01J 39/18

(57) ABSTRACT

A deionization device for liquids includes a first chamber for a first ion exchange agent that has a first intake opening and a first discharge opening. A second chamber for a second ion exchange agent has a second intake opening and a second discharge opening. A line connects the first chamber and the second chamber that has a third intake opening and a third discharge opening. The third intake opening is dedicated to the first discharge opening of the first chamber and the third discharge opening is dedicated to the second intake opening of the second chamber. The line also has a first regeneration opening for a first regeneration liquid, wherein the first regeneration opening can be closed for deionization, and wherein the line can be closed for regenerating the deionization device such that the third intake opening can be isolated from the third discharge opening.

### CROSS-REFERENCE TO RELATED APPLICATIONS

This application is the U.S. national stage of PCT/EP2016/082336 filed Dec. 22, 2016, which claims priority of German Patent Application No. 102015122761.4 filed on Dec. 23, 2015, which is incorporated herein by reference in its entirety.

### FIELD OF THE INVENTION

The invention relates to a deionization device for liquids. Furthermore, the invention relates to a connection adapter for a deionization device and a method for regeneration of a deionization device.

### BACKGROUND OF THE INVENTION

Deionized liquids, in particular deionized water, are necessary for operating various industrial plants, e.g. erosion machines. Known devices usually involve a two-step deionization, wherein first cations and then anions are filtered out of the liquid. A deionization device for liquids comprises a first chamber, generally in the form of a column, for a first ion exchange agent, e.g. a cation exchange resin, which has a first intake opening and a first discharge opening, a second chamber adjacent to the first chamber, likewise normally in the form of a column, for a second ion exchange agent, e.g. an anion exchange resin, which has a second intake opening and a second discharge opening, as well as a line connecting the first chamber with the second chamber. This line has a third intake opening and a third discharge opening. The third intake opening is dedicated to the first discharge opening of the first chamber. The third discharge opening is dedicated to the second intake opening in the second chamber. In this manner, a liquid can first flow through the first chamber, wherein cations are filtered out. Subsequently, the liquid can flow to the second chamber via the line, wherein anions are then filtered out.

After being in operation for some time, the ion exchange agents become exhausted and must be replaced or regenerated. By adding a regeneration liquid, the filtering capability of the respective ion exchange agent can be regenerated. Because different regeneration liquids are necessary for different ion exchange agents, it is not possible to conduct the regeneration liquid, or the regeneration liquids, through the deionization device along the same pathway as a liquid that is to be deionized. Instead, the regeneration liquids in question must be added separately to the chambers with the respective ion exchange agents. Moreover, the regeneration liquids must be removed separately. With the known deionization devices, this sometimes requires disassembly, e.g. to remove the chambers. With the deionization device known from EP 0 807 605 B1, the line must be removed and replaced by a separate intake and discharge line for the chambers.

Known deionization devices therefore have the disadvantage that a regeneration can only be achieved with a good deal of assembly effort, requiring a lot of time.

The object of the present invention is to thus create an improved deionization device, an improved connection adapter, and an improved regeneration method, which enable a regeneration that is particularly simple and quick, and therefore also cost-effective.

Further advantageous developments can be derived from the following description, the drawings and the dependent claims. The individual features of the further developments described herein are not limited thereto, but instead can be combined with one another and with other features.

### SUMMARY OF THE INVENTION

According to the invention, the line in the deionization device described in the introduction also has a first regeneration opening for a first regeneration liquid. The first regeneration opening can be closed for deionization. In order to regenerate the deionization device, the line can be closed such that the third intake opening can be isolated from the third discharge opening. It is thus advantageously possible to achieve regeneration without removing the chambers or the line, because the chambers can be decoupled from one another.

The chambers can preferably be formed as columns, disposed one is inside the other. This results in a particularly compact deionization device. Particularly preferably, the chambers can be formed as concentric columns, in order to enable a uniform liquid distribution when the deionization device is in operation.

The line also has a second regeneration opening for a second regeneration liquid, wherein the second regeneration opening can also be closed for deionization, and wherein the line can be closed for regenerating the deionization device such that the third intake opening and the first regeneration opening can be isolated from the second regeneration opening and the third discharge opening. As a result of the two regeneration openings and the respective intake and discharge openings in the chambers, two different regeneration liquids can be introduced or removed simultaneously in a particularly quick and simple manner, without ending up in the other chambers.

The deionization device has at least one mechanical closure according to a further development. It may be conceivable with long operating cycles to heat-seal the first and second regeneration openings, but mechanical closures can be opened with less effort. For this reason, mechanical closures are preferred as the closure means, e.g. stoppers, valves, latches, screw-caps and suchlike.

In a further development, the first regeneration opening, the second regeneration opening and/or the line can be closed off by means of the closure. As a result, the first regeneration opening, the second regeneration opening and/or the line can be readily opened or closed.

The closure is dedicated to the first discharge opening, the second intake opening, the third intake opening, the third discharge opening, the first regeneration opening, and/or the second regeneration opening in a further development. The closure is dedicated to the respective opening as intended with the invention, when the closure is disposed such that a flow to or from the respective opening can be interrupted by the closure.

The closure is disposed in the line between the third intake opening and the first regeneration opening at one end, and between the second regeneration opening and the third discharge opening at the other end in a further development. Advantageously, it is then possible to decouple the chambers with just one closure.

According to a further development, the closure comprises at least one connection adapter for a regeneration liquid infeed line and/or a regeneration liquid removal line. As a result of the multifunctional connection adapter, separate closure and connection adapters are superfluous. As a result, closure and introduction or removal of regeneration liquids can be obtained with a single component and a single manipulation thereof. In this manner, the regeneration can take place particularly quickly and easily.

The connection adapter is designed in a further development such that it can be disposed at least partially in the first regeneration opening and the third intake opening and/or at least partially in the second regeneration opening and the third discharge opening. In this manner, it is possible to quickly and easily add and remove regeneration liquid from the first and/or second chamber by means of the adapter, because it can be inserted simultaneously into the first regeneration opening and the third intake opening, and/or simultaneously into the second regeneration opening and the third discharge opening.

In order to prevent unintentional leakage of the regeneration liquid, the connection adapter can preferably be disposed in a sealing manner in the third intake opening and/or the third discharge opening. For this, the connection adapter can be designed such that is corresponds at least in part to the third intake opening and/or the third discharge opening. As a result, the connection adapter can be advantageously disposed in these openings in a form-fit and/or force-fit manner. By way of example, the connection adapter can be disposed in a sealing manner by providing one or more sealing rings, or due to the material of the connection adapter itself, which can have a region produced with a 2-component injection process in the region of the opening that is to be sealed, which has a softer outer material, for example.

Furthermore, the connection adapter can have at least one projection, by means of which the connection adapter can be secured in a releasable manner to the deionization device. This projection is preferably in the form of a flange.

The connection adapter can also have a retention plate, which can be secured to the housing of the deionization device, preferably the housing lid. By way of example, the retention plate can be secured with screws. The retention plate preferably has at least one opening for receiving a section of the connection adapter. The retention plate can bear at least in part on the projection, and be secured to the housing of the deionization device such that it is clamped onto the projection on the connection adapter in order to retain it.

Furthermore, at least one seal, e.g. a gasket, can be disposed in the region of the third intake opening and/or the third discharge opening, as well as on the connection adapter itself.

According to a further development, the connection adapter has at least one first stopper section, in particular in the form of a tube. The connection adapter can be disposed in a form-fit and/or force-fit manner in the respective openings by means of the first stopper section, wherein this also makes it possible to add or remove regeneration liquid through the stopper section.

In a further development, the connection adapter has a first stopper section and a second stopper section, in particular in the form of a tube. Advantageously, two different regeneration liquids can be simultaneously added to or removed from the two chambers through the two stopper sections. As a result, regeneration can be achieved particularly quickly. The first and second stopper sections, in particular formed as tubes, can each have a flange-like projection. Furthermore, the first and second stopper sections can be connected to one another by means of a retention plate. For this, the retention plate can have holes for receiving the first and second stopper sections respectively. Furthermore, the retention plate can be connected to the deionization device with screws or other fasteners in order to obtain a releasable attachment of the first and second stopper sections during regeneration.

In order to be able to secure the connection adapter in place, the connection adapter has at least one threading in a further development. This can be formed, for example, in the region of the stopper sections.

According to a further development, the first regeneration opening and the third intake opening are flush with one another, such that the connection adapter can be inserted particularly easily into these openings. Alternatively or additionally, the second regeneration opening and the third discharge opening are also flush with one another.

In a further development, the third intake opening, the third discharge opening, the first regeneration opening and/or the second regeneration opening have a threading for a secure placement of a closure, and in particular a connection adapter, thereon. Alternatively, gaskets or sealing regions can also be provided, at which an outer region of the closure and/or the connection adapter bears on the specific opening in a sealing manner.

The deionization device has a housing in a further development. This housing can be portable, and may thus have handles and wheels.

In order to make the housing easier to produce, and to be able to easily service the deionization device, the housing has a lid in a further development.

According to a further development, the line is disposed in the housing lid. Advantageously, it is consequently easy to service the line and a potential closure disposed therein.

In order to ensure that the liquid that is to be deionized can flow in an optimal manner through the deionization device, the first intake opening in the first chamber and the second intake opening in the second chamber can each open into a gravity pipe. These gravity pipes preferably extend from the housing lid to a base of the housing. Liquid introduced therein rises in a uniform manner from the base of the chamber, thus flowing through the respective ion exchange agent, until reaching the discharge opening. In order to prevent leakage of the ion exchange agent, inserts can be disposed on the housing lid, which are dedicated to the respective discharge openings of the chambers.

The connection adapter according to the invention for the deionization device described above is designed such that it can be placed at least in part in the first regeneration opening and the third intake opening, and/or at least in part in the second regeneration opening and the third discharge opening. In this manner, an addition and removal of regeneration liquid to or from the first and/or second chamber can be achieved in a particularly simple manner by means of the adapter, because the adapter can be inserted simultaneously into the first regeneration opening and the third intake opening, and/or simultaneously into the second regeneration opening and the third discharge opening.

In order to prevent unintentional leakage of the regeneration liquid, the connection adapter can preferably be disposed in a sealing manner in the third intake opening and/or the third discharge opening. For this, the connection adapter can be designed such that it corresponds at least in part to the third intake opening and/or the third discharge opening. As a result, the connection adapter can be advantageously place in these openings in a form-fit and/or force-fit manner.

Furthermore, the connection adapter can have at least one projection, so that it can be secured in a releasable manner to a deionization device. This projection is preferably in the form of a flange.

The connection adapter can have a retention plate, which can be secured to the housing of a deionization device, preferably on the lid thereof. By way of example, the retention plate can be secured by means of screws. The retention plate preferably has at least one opening for receiving a section of the connection adapter. The retention plate can bear at least in part on the projection, and also be secured to the housing of the deionization device, in order to clamp onto the projection of the connection adapter to retain it in place.

The connection adapter has at least one first, in particular tube-shaped, stopper section according to a further development. The connection adapter can be form-fit and/or force-fit to the respective opening by means of the tube-shaped stopper section, wherein an addition and removal of regeneration liquid is also enabled by the stopper section.

In a further development, the connection adapter has a first stopper section and a second, in particular tube-shaped, stopper section. Addition and removal of regeneration liquid to or from the two chambers can take place simultaneously through the two, in particular tube-shaped, stopper sections. As a result, a particularly time-saving regeneration can be obtained. The first and second stopper sections can each have a flange-like projection. Furthermore, the first and second stopper sections can be connected to one another by means of a retention plate. For this, the retention plate can have respective openings for the first and second stopper sections. Furthermore, the retention plate can be connected to a deionization device by means of screws or other fasteners such that it can be secured thereto in a releasable manner.

In order for the connection adapter to be attached to a deionization device in particular in a sealed manner, the connection adapter has at least one threading and/or one or more gaskets or sealing regions in a further development. In particular, the connection adapter can be attached in a sealing manner due to its material, e.g. in that the connection adapter has a region produced with a 2-component injection process that has a softer outer material.

In accordance with the method according to the invention for regenerating the deionization device described above, which has a first and a second regeneration opening, the first and/or the second regeneration openings are opened, wherein the line is closed off by a connection adapter according to the invention described above, such that the third intake opening and the first regeneration opening are isolated from second regeneration opening and the third discharge opening. For this, the connection adapter is placed at least partially in the first regeneration opening and the third regeneration opening, and/or at least partially in the second regeneration opening and the third discharge opening. The first regeneration liquid is then introduced into the first chamber through the connection adapter, and removed therefrom through the first intake opening, or vice versa. Alternatively or additionally, a second regeneration liquid is introduced into the second chamber through the second discharge opening and removed therefrom through the connection adapter, or vice versa. The regeneration agent is added and removed during the deionization counter to the direction of flow, in order to conserve regeneration liquid.

In a further development, the connection adapter is attached to the deionization device by means of a threading and/or the gasket or the sealing region. The threading and/or the gasket or sealing region is preferably formed on the third intake opening and/or the third discharge opening.

### BRIEF DESCRIPTION OF THE DRAWINGS

Further advantageous developments can be derived from the following drawings. The illustrations contained therein are not to be interpreted as limiting, however, but instead, the features described in reference thereto can be combined with the features described above to form further embodiments. Moreover, it should be noted that the reference symbols used in the figures do not limit the scope of protection for the present invention, but instead refer merely to the embodiments shown in the figures. Identical components or components with identical functions have the same reference symbols in the following. Therein:

FIG. 1 shows an embodiment of a deionization device according to the invention in a perspective illustration;

FIG. 2 shows a perspective view of a cross section of the deionization device according to FIG. 1;

FIG. 3 shows an enlarged perspective partial view of a cross section of the deionization device according to FIG. 1;

FIG. 4 shows an enlarge perspective partial view of a longitudinal section through the deionization device according to FIG. 1;

FIG. 5 shows an enlarged perspective partial view of the deionization device according to FIG. 1 in a sectional view;

FIG. 6 shows an enlarged perspective partial view of a section of the deionization device according to FIG. 1, with an embodiment of a connection adapter according to the invention in a longitudinal section.

### DETAILED DESCRIPTION OF THE PREFERRED EMBODIMENTS

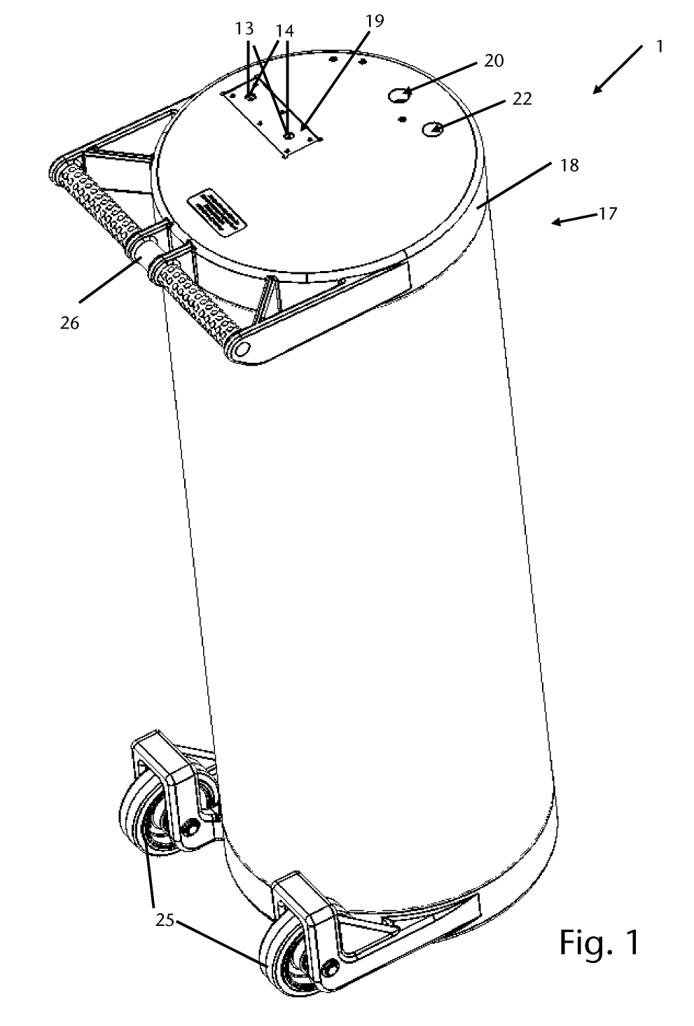

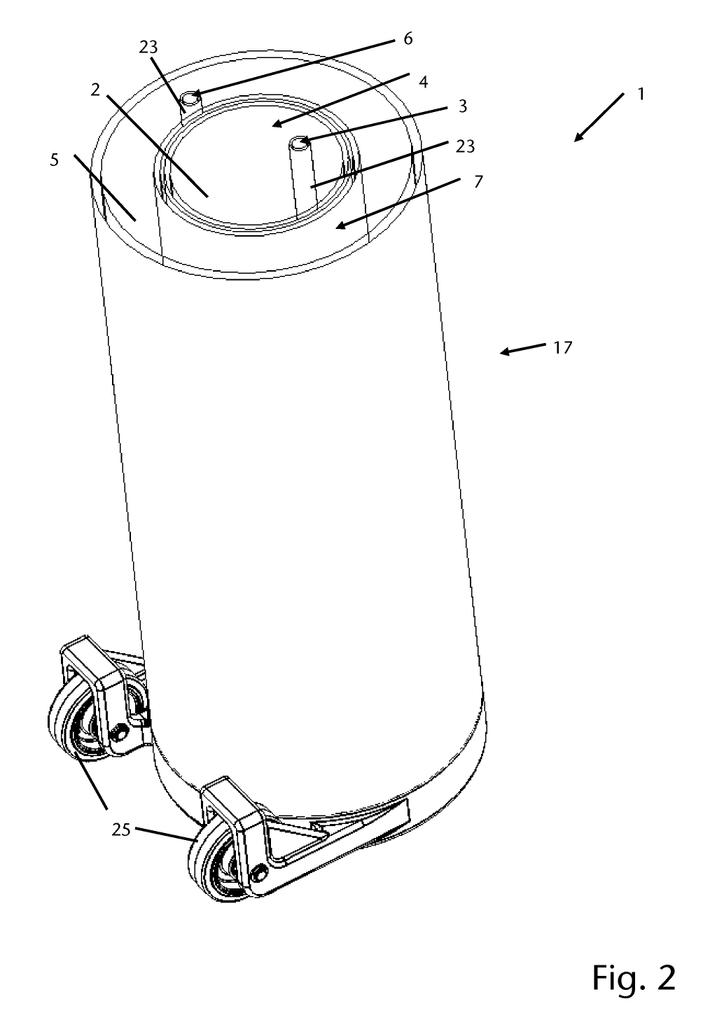

FIG. 1 shows an outer view of an embodiment of a deionization device 1 according to the invention, and FIG. 2 discloses a corresponding inner view of the deionization device 1. This has a first chamber 2 for an ion exchange agent, which has a first intake opening 3 and a first discharge opening 4. The first chamber 2 is in the form of a column, and disposed concentrically in a second chamber 5 for a second ion exchange agent. The second chamber is likewise in the form of a column, and has a second intake opening 6 and a second discharge opening 7.

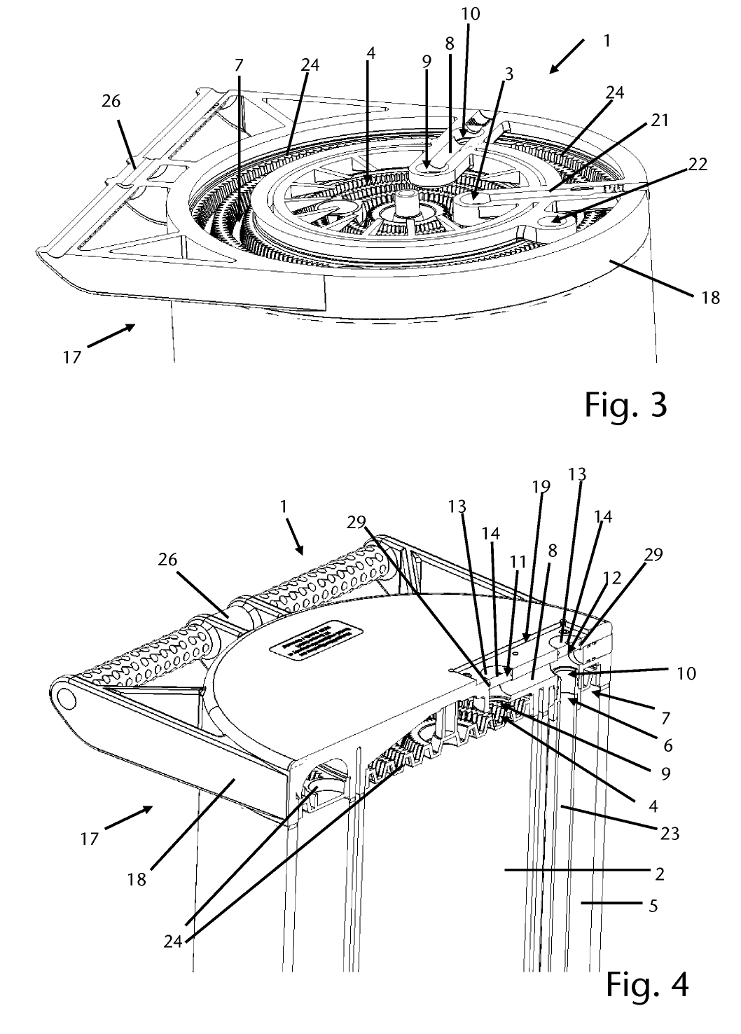

As shown in FIG. 3, the first chamber and the second chamber 5 are connected by a line 8. This line 8 has a third intake opening 9 and a third discharge opening 10. The third intake opening 9 is dedicated to the first discharge opening 4 of the first chamber 2. The third discharge opening 10 is dedicated to the second intake opening 6 in the second chamber 5. In order to deionize a liquid, it is first introduced into the first chamber through the first intake opening 3. A first step of the deionization can take place there through a first ion exchange agent, e.g. a cation exchange resin. The liquid can then exit the first chamber 2 though the first discharge opening 4. The liquid can be removed via the third intake opening 9 in the line 8. The liquid exits the line 8 forming an overflow line through the third discharge opening 10, and then enters the second chamber 5 through the second intake opening 6. The liquid can be deionized in a second step in the second chamber 5 through a further ion exchange agent, e.g. an anion exchange resin. The deionized liquid than then be removed for further use through the second discharge opening 7 in the second chamber 5.

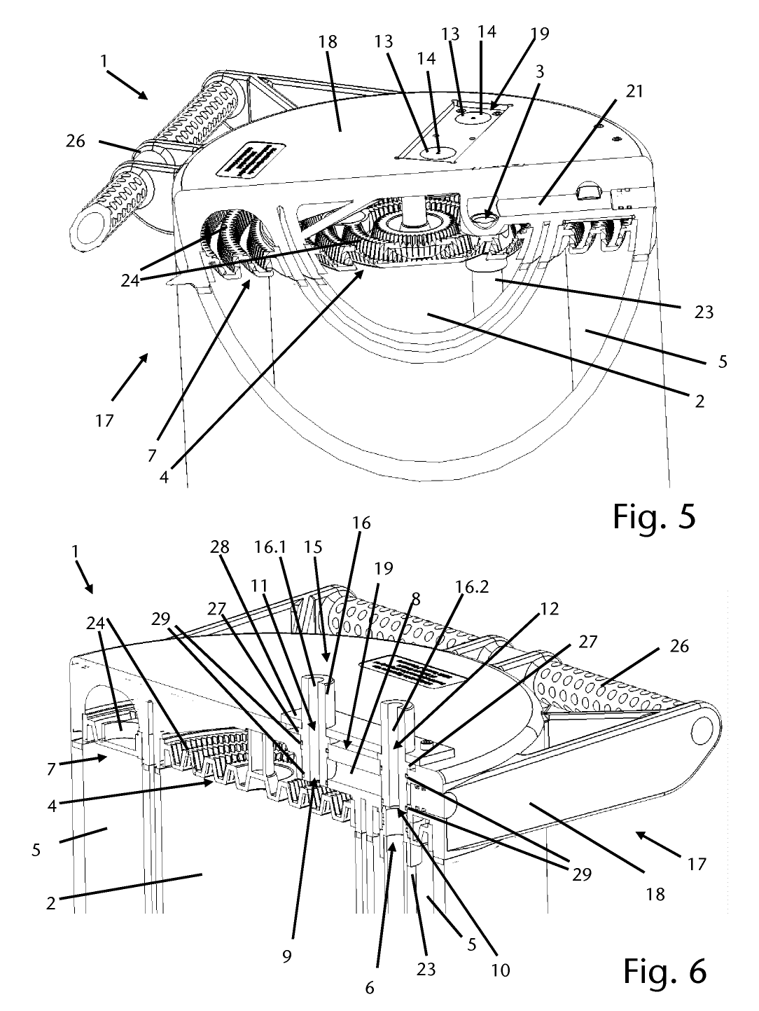

As FIG. 4 shows, the line 8 also has a first regeneration opening 11 for a first regeneration liquid, and a second regeneration opening 12 for a second regeneration liquid. In order to prevent leakage of the liquid that is to be deionized, closures 13 are disposed in the first regeneration opening 11 and the second regeneration opening 12. These closures 13 are formed as stoppers 14, as shown in FIG. 5.

FIG. 5 shows that the deionization device 1 according to the invention has an encompassing housing 17 with a housing lid 18, as also shown in FIGS. 1 to 4. The line 8 is disposed in this housing lid 18, as also shown in FIGS. 3 and 4. The first regeneration opening 11 and the second regeneration opening 12 in the line 8 open into the housing lid 18. The housing lid 18 has a recess 19 in the region of the openings. A cover plate for covering the first regeneration opening 11 and the second regeneration opening 12, as well as the stoppers placed thereon, can be disposed in the recess 19. The housing lid 18 also has a lid intake opening 20, for conducting a liquid into the deionization device 1, as shown in FIG. 1. The lid intake opening 20 opens into a lid intake line 21, which leads to the first intake opening 3 in the first chamber 2. In order to remove the deionized liquid, the housing lid 18 has a lid discharge opening 22, dedicated to the second discharge opening 8 in the second chamber 5, as shown in FIG. 1.

As shown in FIG. 6, a connection adapter 15 is disposed in the first regeneration opening 11 and the second regeneration opening 12 in the line 8 for introducing and/or removing a first and second regeneration liquid instead of the stoppers 14, for regenerating the deionization device 1 according to the invention. The connection adapter 15 has two tube-shaped stopper sections 16, specifically a first tube-shaped stopper section 16.1 and a second tube-shaped stopper section 16.2. The first regeneration opening 11 and third intake opening 9 are flush with one another. The first tube-shaped stopper section 16.1 has a design corresponding to the aforementioned openings. Furthermore, the second tube-shaped stopper section 16.2 is disposed in the regeneration opening 12 and the third discharge opening 10. The second regeneration opening 12 and the third discharge opening 10 are likewise flush with one another. The second tube-shaped stopper 16.2 extends from the second regeneration opening 12 to the third discharge opening 10, and is designed in a manner corresponding to this opening. The first regeneration opening 11 and the third intake opening 9 are isolated by the connection adapter 15 from the second regeneration opening 12 and the third discharge opening 10 for a regeneration of the deionization device.

For a regeneration of the assembly shown in FIG. 6, the respective regeneration liquid is added to and removed from the chamber 2 and 5 in a direction counter to the flow. A first regeneration liquid is introduced accordingly into the first chamber 2 through the first tube-shaped stopper section 16.1 through the first discharge opening 4, and removed from the first chamber 2, or the deionization device 1, respectively, via the first intake opening 2, the lid intake line 21, and the lid intake opening 20, see FIG. 1. Furthermore, a second regeneration liquid is introduced into the second chamber 5 via the lid discharge opening 22 and the second discharge opening 7, and removed from the second chamber 5, or the deionization device 1, respectively, via the second intake opening 6 and the second tube-shaped stopper section 16.2.

The first intake opening 3 of the first chamber 2 and the second intake opening 6 of the second chamber each open into a gravity pipe 23, see FIGS. 2, 4 and 5. These gravity pipes 23 extend from the housing lid 18 to a base of the housing 17, not shown. Inserts 24 are disposed on the housing lid 18, which are dedicated to the respective discharge openings 4, 6 in the chambers 2, 5. The housing 17 also has wheels 25, as well as handles. 26.

FIG. 6 also shows that the two tube-shaped stopper sections 16.1, 16.2 have projections 27. The two tube-shaped stopper sections 16.1, 16.2 of the connection adapter 16 are secured to the housing lid 18 by a retention plate 28, which is screwed into the holes 19 in the housing lid 18, and bears on the projections 27. The two tube-shaped stopper sections 16.1, 16.2 also have seals 29. The stoppers 14 also have seals of this type 29, see FIG. 4.

1. A deionization device for liquids, comprising:
a first chamber for a first ion exchange agent that has a first intake opening and a first discharge opening, a second chamber for a second ion exchange agent that has a second intake opening and a second discharge opening, a line for connecting the first chamber and the second chamber, that has a third intake opening and a third discharge opening, wherein the third intake opening is dedicated to the first discharge opening of the first chamber and the third discharge opening is dedicated to the second intake opening of the second chamber, wherein the line also has a first regeneration opening for a first regeneration liquid, wherein the first regeneration opening is closed for deionization, and wherein the line is closed for regenerating the deionization device such that the third intake opening can be is isolated from the third discharge opening.

2. The deionization device according to claim 1, wherein the line has a second regeneration opening for a second regeneration liquid, wherein the second regeneration opening is closed for regenerating the deionization device and wherein the line is closed for regenerating the deionization device such that the third intake opening and the first regeneration opening are isolated from the second regeneration opening and the third discharge opening.

3. The deionization device according to claim 1, wherein the deionization device also has at least one mechanical closure, wherein the first regeneration opening, the second regeneration opening, and/or the line are closed by the closure.

4. The deionization device according to claim 3, wherein the closure is dedicated to the first discharge opening, the second intake opening, the third intake opening, the third discharge opening, the first regeneration opening and/or the second regeneration opening.

5. The deionization device according to claim 3, wherein the closure is disposed in the line between the third intake opening and the first regeneration opening at one end, and between the second regeneration opening and the third discharge opening at another end.

6. The deionization device according to claim 3, wherein the closure comprises at least one stopper.

7. The deionization device according to claim 3, wherein the closure comprises at least one valve.

8. The deionization device according to claim 3, wherein the closure comprises at least one connection adapter for introducing and/or removing a regeneration liquid.

9. The deionization device according to claim 8, wherein the connection adapter is disposed at least partially in the first regeneration opening and the third intake opening, and/or at least partially in the second regeneration opening and the third discharge opening.

10. The deionization device according to claim 8, wherein the connection adapter comprises at least one tube-shaped stopper section.

11. The deionization device according to claim 10, wherein the connection adapter comprises a first tube-shaped stopper section and a second tube-shaped stopper section.

12. The deionization device according to claim 8 wherein, the connection adapter comprises at least one threading.

13. The deionization device according to claim 1, wherein the first regeneration opening and the third intake opening are flush with one another, and/or in that the second regeneration opening and the third discharge opening are flush with one another.

14. The deionization device according to claim 1 wherein the third intake opening, the third discharge opening, the first regeneration opening and/or the second regeneration opening comprise(s) a threading.

15. The deionization device according to claim 1 wherein the deionization device also comprises a housing that has a housing lid wherein the line is disposed in the housing lid.

16. A connection adapter for introducing a regeneration liquid and/or removing a regeneration liquid for regenerating a deionization device according to claim 8 wherein the connection adapter is disposed at least partially in the first regeneration opening and the third intake opening, and/or at least partially in the second regeneration opening and the third discharge opening.

17. The connection adapter according to claim 16, wherein the connection adapter comprises at least one tube-shaped stopper section.

18. The connection adapter according to claim 17, wherein the connection adapter comprises a first stopper section and a second stopper section.

19. The connection adapter according to claim 16, characterized in that the connection adapter comprises at least one threading.

20. A method for regenerating a deionization device according to claim 2, wherein the first regeneration opening and/or the second regeneration opening is/are opened, wherein the line is closed by a connection adapter such that the third intake opening and the first regeneration opening are isolated from the second regeneration opening and the third discharge opening, wherein the connection adapter is disposed at least partially in the first regeneration opening and the third intake opening for this, wherein a first regeneration liquid is introduced into the first chamber through the connection adapter, and removed therefrom through the first intake opening, or vice versa, and/or is disposed at least partially in the second regeneration opening and the third discharge opening, and wherein a second regeneration liquid is introduced into the second chamber through the second discharge opening and removed therefrom through the connector adapter vice versa.

21. The method for regenerating the deionization device according to claim 20, wherein the connection adapter is secured in place on the deionization device by a threading.
